(19) United States
(12) Patent Application Publication
(10) Pub. No.: US 2017/0165510 A1
(43) Pub. Date: Jun. 15, 2017

(54) A FIRE EXTINGUISHING METHOD AND A FIRE EXTINGUISHING PROJECTILE

(71) Applicant: Torres Servicios Tecnicos, S.L., Vilassar de Dalt (ES)

(72) Inventor: Jordi Miquel Torres Muñoz, Vilassar de Dalt (ES)

(21) Appl. No.: 15/325,625

(22) PCT Filed: Jul. 10, 2015
(86) PCT No.: PCT/ES2015/070538

§ 371 Date: Jan. 11, 2017

(30) Foreign Application Priority Data
Jul. 11, 2014 (ES) P201431056

(51) Int. Cl. A62C 3/02; A62C 99/00

(52) U.S. Cl. CPC A62C 3/025; A62C 99/0045

(57) ABSTRACT

A method for extinguishing fires which includes the following phases: a first phase wherein a projectile of compact crushed ice is produced, with a volume between 0.5 liters and 2 liters, a second phase wherein the projectile is placed on a shuttle that fires it over the area in flames to be put out, and a third phase wherein successive projectiles are launched until a shower of compact crushed ice projectiles is formed with at least 30 liters per square meter per hour. A projectile for extinguishing fires is also disclosed.

Method for extinguishing fires and projectile for extinguishing fires.

Method for extinguishing fires and projectile for extinguishing fires comprising the following phases: a first phase wherein a projectile of compact crushed ice is produced, with a volume between 0.5 litres and 2 litres, a second phase wherein said projectile is placed in a shuttle that fires it over the area in flames to be put out, and a third phase wherein successive projectiles are launched until a shower of compact crushed ice projectiles is formed with at least 30 litres per square metre per hour.

### BACKGROUND TO THE INVENTION

In the state of the art different methods for putting out fires are known, which use ice.

One state of the art document is U.S. Pat. No. 5,507,350 “Fire extinguishing with dry ice” from the year 1996 comprising a method for extinguishing fires with capsules of dry ice. The dry ice projectiles comprising a block of carbon dioxide encapsulated in an insulating material that lights and breaks up quickly, releasing the block of ice. The inventors of said patent consider said method of launching the dry ice projectiles particularly for isolating the seat of the fire.

Also Moldavian patent MD20110067 “Agent de stingere si localizare a incendiului” from the year 2011 and the object of the invention is an agent structure in the shape of a cryogenic pump the body of which mainly comprises ice. Inside this structure of ice, we find natural gas hydrate crystals, a tube of carbon dioxide, an explosive and movement and/or temperature sensors. The effect of the extinction comprises the combined action of the detonation wave caused by the explosion, extinguishing the substances contained in the agent body, multiple distributions of gas and water vapour due to the action of cryogenically preserved substances.

A series of documents comprise the mixture of water and ice as the extinguishing agent.

So Chinese Patent CN102940944 “Ice slurry fire extinguishing system” from the year 2013 describes a system for extinguishing fires with a mixture of ice and water. The system for extinguishing fires in the form of an ice mixture reduces half the extinction time and inner temperature of the seat of the fire, reducing the amount of water needed. Said system comprises a compressor, a condenser, an expansion valve, a cooling fluid inlet of an evaporator, a cooling fluid outlet of an evaporator and a compressor that are connected sequentially to one cooling fluid circulation side; a water outlet from the evaporator, a storage tank for the ice mixture, a circulation pump and a water inlet of the evaporator that are connected successively over a water circulating side; and the ice mixture storage tank, a high pressure injection pump and an extinguishing nozzle are connected successively.

Document US2004216901 “Fire retardant delivery system” from the year 2004, describes a method of extinguishing fires and suppressing the fire, comprising the phases of encapsulating the fire extinguishing agent in liquid or gaseous form inside a housing the cover of which is in a solid format. An agent such as iced water or liquid carbon dioxide is useful when used as a “non-lethal” device. The solid wrapping is sublimatable and bursts at the moment of impact or following exposure to the environment conditions in the place, in order to release the contents of the housing, as well as the fragments of the container housing in the place of impact.

And finally, several documents are quoted which use only ice as the agent (in the form of blocks or crushed ice).

Chinese Utility Model CN201949523 “Fire-fighting device” from the year 2011 claims a fire extinguishing device comprising an ice launching device, an automatic load firing device, an ice production device, and a firing activating device. The load and the scope of the device is adjustable, the ice melts quickly when it reaches the seat of the fire.

Another Chinese Utility Model CN201347769 “Tunnel fire-fighting vehicle with track through ice blocks”, from the year 2009, comprises a vehicle designed especially for extinguishing fires in tunnels. It comprises a conveyor belt in a train carriage, driven by an electric motor. Said conveyor belt carries the ice blocks for the ice-launching machine.

The following three documents are considered more relevant to the object of our search, since they use ice as the only extinguishing agent.

Thus, German patent DE102008036815 “Verfahren and Vorrichtung zur Brandbekämpfung” from the year 2010 describes a method of diffusing crushed ice or ice in pieces, over the surface of the fire. The crushed ice or the ice in pieces is used as an extinguishing agent. An explosive pump comprises a frozen hollow body full of crushed ice. The explosive pump is transported to the source of fire using a vehicle. The method is particularly useful for fighting against large-scale forest fires and fires in a tunnel or oil well.

PCT WO03/024536 “Fire-fighting apparatus and a method of fighting fire” from the year 2003, claims a device for extinguishing fires containing ice in water as a fire extinguishing means. The fire extinguishing means is contained in a tank in the apparatus. Said tank can be thermally insulated. Also, said device can comprise an ice machine for making and storing the ice in situ. Said ice machine can operate by means of a vapour compression cycle or by means of a vacuum system. Said ice making machine can be connected to a water source, including sea water.

Spanish Patent ES2329325 “Sistema de extincion de incendios mediante liquidos congelados” from the year 2007, and in force, describes a system for extinguishing fires using frozen liquids, based on freezing a liquid in the form of small blocks or ice cubes, using a freezing apparatus and launching the frozen blocks using a pneumatic cannon-like device over the fire to be extinguished.

It is also worth mentioning American U.S. Pat. No. 5,461,874 “METHOD AND APPARATUS FOR TRANSPORTING MATERIAL”, from the year 1993, which relates to a method for putting out fires, for example, using a cannon assembled on a truck that sends a projectile which, depending on the type of fire, changes its composition. This way, in columns 7 (line 56 and so on) and column 8 (line 2 and so on) a projectile is mentioned with a column of ice the inside of which is made up of water, either cold or in a frozen state.

### BRIEF DESCRIPTION OF THE INVENTION

This application comes into the sector of methods for putting out fires based on the use of ice.

The closest document is American U.S. Pat. No. 5,461,874, which would anticipate Spanish Patent ES2329325.

Said patent has the advantage that the low temperature of the ice cools the fuels more, the ice remains for longer applying the suffocating effect, and the ice projectiles are sent wherever necessary, impacting, for example, some plants or areas and not others.

Both the closest document and the background documents have not been started up because of a problem, and that is because when the ice collides with a surface, it often gives off sparks that can revive the fire, even in areas that were without fire. Therefore, the use of ice projectiles has been discarded.

The inventor has made calculations and has reached the conclusion that it is possible to continue using ice projectiles, but in the form of a shower of ice projectiles, with a cadence of at least 30 l/m²·h and optimally 35 l/m²·h.

This means that even when a spark could be generated, the water thawing from the other projectiles would put it out and also, with said cadence of shots, the air would not be abundant and therefore it would hinder fire propagation.

Another of the advances to prevent the projectile from generating sparks at the moment of impact is the fact that the projectile is made up of spheres of water solution in the form of ice with freshwater as the binding agent. The ice solution is made up of a fire retardant and water with a freezing point of approximately −4° C. The freshwater that acts as binding agent has a freezing point of 0° C. The projectile is produced by the combination of the ice and the water in a projectile-shaped mould and its fast freezing, producing a compact projectile.

This way the projectile binding agent can melt when it approaches the seat of the fire, and the ice reaches the seat of the fire more extensively, covering more surface area and distributing the crushed ice more uniformly, consequently putting out the fire and neutralising any spark that may have been generated. This avoids the great impact of the block of homogenous ice hitting the seat of the fire and generating sparks that propagate the fire in other places.

This project introduces a considerable advance in the means for extinguishing fire for the following advantages:
Putting out performance over 200% using ice projectiles instead of the usual water, thanks to its greater cooling, since it remains for longer in the area of the fire and because of its speed in putting it out.
It fires ice projectiles continuously 24 hours a day, day and night.
The system works irrespectively of the conditions regarding wind, fog, electric clouds or rain in the action area.
The flow rate of the ice projectiles is, for example, 35 m²/h, which would be equivalent to a strong rain of 35 mm/h·m² in 1000 m².
Reducing the time for putting out forest fires by at least half, and exponentially eliminating the damage caused by the fire.
Projectile scope in fires between 100 m and more than 5 km away, and 2000 metres high.
Fast operation start up.
Average investment cost, but low operating cost.

An object of this invention is a method for extinguishing fires characterised in that it comprises the following phases: a first phase wherein a projectile of compact, crushed ice is produced, with a volume between 0.5 litres and 2 litres, a second phase wherein said projectile is placed in a shuttle that fires it over the area in flames to be put out, and a third phase wherein successive projectiles are launched until a shower of compact crushed ice projectiles is formed with at least 30 litres per square meter per hour.

An additional object of this invention is a projectile for extinguishing fires of the type made from ice characterised in that the said ice is crushed and compact.

### SPECIFIC EMBODIMENT OF THIS INVENTION

In a specific embodiment, in a previous phase a mobile facility would be provided, with a shuttle, freezing means, generators and a water supply means, at a distance of for example 2 km. from the location of the fire.

This means that there is no danger of the fire affecting the various brigades taking part in extinguishing the fire.

Once the mobile equipment is arranged in the place indicated, the preparation would begin, comprising the following phases.

A first phase wherein a projectile of compact crushed ice is produced, with a volume between 0.5 and 2 litres, by the freezing means.

The volume, as will be explained later, is determined by the shuttle's capacity to send a shower of projectiles, over a long distance and so that they arrive still in the form of compact crushed ice.

Therefore, it may be necessary to conduct some prior firing tests so that the volume of the projectile, the parabola and launch distance and the freezing temperature can be adjusted so that the projectile reaches the seat of the fire with the binding part melting and distributing the crushed ice with the solution containing the fire retardant. These adjustments overcome the factors of outside temperature and wind that could affect the effectiveness of the projectile and its characteristics.

Subsequently, in a second phase, said projectile is placed in a shuttle, where it is arranged at a height and with strength according to the conditions mentioned above and the location of the fire. The shuttle then fires the projectile over the area in flames to be put out, where it lands, hitting the area of the fire.

During the flight, the projectile made up of the ice and the frozen water as the binding agent suffers from the friction of the air, the sun's heat and the temperature of the actual fire, which helps to melt the binding agent so that the crushed ice can reach its destination and be distributed much more effectively all over the area of the fire.

This is also beneficial because it prevents any sparks that may revive the fire, which was one of the problems in the background to the invention.

Next, in the third phase successive projectiles are launched until a shower of compact, crushed ice projectiles is formed. This is done in order to wet the whole area affected by the fire and, at the same time, to put out and drown the flames.

The cadence has to be such that it reaches at least 30 litres per square metre per hour. The inventor proposes, on average, that the cadence reaches 35 litres per square meter per hour, although in certain fires and depending on the type of land, 20 litres per square metre per hour may be sufficient.

Generally, for an area like the Spanish Mediterranean and with a shower of projectiles between 30 and 40 litres per square metres per hour, the projectile could have a volume of 1 litre, even though this may be modified depending on the conditions mentioned above and particularly the shuttle.

The shuttle could be one cannon of compressed air with a height regulator, which could be adapted to the prevailing wind conditions, and change its scope.

The said shuttle would also comprise cooling means to compensate the heat from the friction between the projectile and the shuttle cannon. This is so that upon exit the friction does not reduce the projectile's effectiveness, this way the previsions regarding the scope, compactness, etc. of the projectile are maintained.

One of the greatest advantages is that this method can be used both at night, and even with wind, since the firing can be corrected with the shuttle, and the projectile can be sent to areas that are difficult to access, which is often complicated for hydroplanes and helicopters.

Below is a comparison, to be combined with the detailed one shown later, of the effectiveness of this method and projectile, at different distances:

### Scopes According to Type of Projectiles:

| Projectile | Exit | Tilting | Max. Theoretical | | Flight |
|---|---|---|---|---|---|
| Mass | Speed | Angle | Range | Height | Time |
| 570 g | 160 m/s | 45° | 2612 m | 653 m | 23 s |
| 829 g | 210 m/s | 45° | 4500 m | 1125 m | 30 s |
| 1088 g | 240 m/s | 45° | 5878 m | 1469 m | 35 s |

In other words, this method prevents those taking part in extinguishing fires from putting their lives in danger, since the equipment is at a considerable distance from the fire, for example 2 km.

The projectile for extinguishing fires will be made up of ice characterised in that this ice is a mixture of fire retardant solution in the form of crushed ice and frozen water as the binding agent; which helps it to break into small pieces upon impact, like crushed ice, and therefore spread all over the area in flames.

There is also the possibility of adding a colorant or a fluorescent pigment to the ice so that it is possible to follow the projectile's path. Thus, from time to time a projectile is provided that contains said colorant or fluorescent pigment, it is launched and it is possible to really see where it falls. This projectile is particularly useful when extinguishing fires at night.

The inventor has conducted studies to calculate the performance of this invention in relation to the customary use of water by fire-fighters, which is 228% at least, as will be shown below.

To further justify, if necessary, the benefit of this invention, the inventor has compared the putting out strength of water at 20° C. and of the method and projectile that are the object of this invention, at −5° C., as detailed below.

This comparison is based on the cooling power of the water and the ice when used in a fire produced typically forest in an oak wood, with a combustible forest mass of 3308 kg/m², a higher average calorific value of 4572 kcal/kg and, as a result, an energy value in the forest density of 15,124 kcal/m², and a fire propagation speed of 0.001672 m/s.

| DATA ON FOREST MASS | | |
|---|---|---|
| Type of forest: | Oak | |
| Typical forest mass: | 3,308 | kg/m² |
| Average gross calorific value: | 4572 | kcal/kg |
| Forest energy value: | 15124 | kcal/m² |
| Fire propagation speed: | 0.001672 | m/s |
| PHYSICAL DATA OF THE WATER AND ICE | | |
| ca: Specific water heat (current pressure) | 4.18 | kJ/kg · K |
| ch: Specific heat of the ice | 2.11 | kj/kg · K |
| dhf: Specific melting enthalpy | 334 | kj/kg |
| m: Mass | 1000 | kg |
| kcal/kJ conversion factor | 4.187 | |
| HEAT ABSORBED BY THE WATER AT | | |
| 20° C. | | |
| Ti: Initial water temp. | 20° | C. |
| | 293 | K |
| Tf: Final temp. in vapour phase: | 100° | C. |
| | 373 | K |
| Water changing from 20° C. to 100° C. | | |
| Q(ag-v) = m · ca · (Tf − Ti) | 79866 | kcal |
| Q(ag-v) = | | |
| HEAT ABSORBED BY THE WATER: | 79866 | kcal |
| FOREST MASS EXTINGUISHED BY | 17.5 | kg |
| THE WATER | | |
| FOREST SURFACE EXTINGUISHED BY | 5.3 | m² |
| THE WATER | | |
| HEAT ABSORBED BY THE ICE AT −5° C. | | |
| Ti: Initial temp. of ice: | −5° | C. |
| | 268 | K |
| Tc: Freezing temp. | 0° | C. |
| | 273 | K |
| Tf: Final temp. in vapour phase: | 100° | C. |
| | 373 | K |
| Ice changing from −5° C. to 0° C. | | |
| Q(h) = m · ca · (Tc − Ti) | 2520 | kcal |
| Q(ag-v) = | | |
| Ice thawing | | |
| Q(f) = m · dhf | 79771 | kcal |
| Q(f) = | | |
| Water changing from 0° C. to 100° C. | | |
| Q(ag-v) = m · ca · (Tf − Ti) | 99833 | kcal |
| Q(ag-v) = | | |
| HEAT ABSORBED BY THE ICE: | 182123 | kcal |
| FOREST MASS EXTINGUISHED BY | 39.8 | kg |
| THE ICE | | |
| FOREST SURFACE EXTINGUISHED BY | 12.0 | m² |
| THE ICE | | |

### Summarising:

Performance of ice vis-à-vis water in putting out the fire: 228%
Freezing temperature of the crushed ice solution: −10° C.
Freezing temperature of the binding solution: −2° C.
Number of projectiles launched per second: 16 proj/s
Flow rate of ice launched in 1000 m²: 35 m³/h
Measurement of the ice rain: 35 mm/h or 35 litres/m² h, i.e. a very strong rain.

In other words, while 5.3 m² would be put out with water, 12 m² would be covered with the method and projectile of this invention, which means that with the same amount of water, an increased performance of 228% above that of water is achieved, in the same time and without risk for the fire-fighters taking part in the extinguishing tasks.

So, the consumption of absorbed heat to thaw 1000 kg of ice is 79771 kcal, and later the temperature rises from 0 to 100° C. where it evaporates and ceases action against the fire.

The projectile may be spherical, hollow cylindrical, cylindrical of fin shaped, etc.

This invention describes a new method for extinguishing fires and the projectile for extinguishing fires. The examples mentioned herein do not limit this invention, therefore it could have different applications and/or adaptations, all within the scope of the following claims.

1. A method for extinguishing fires comprising the steps of:
producing in a first phase projectiles of compact, crushed ice, each with a volume of between 0.5 liters and 2 liters;
placing in a second phase said projectile in a shuttle cannon that fires it over the area in flames to be put out; and
launching in a third phase said projectiles in succession until a shower of compact crushed ice projectiles is formed reaching at least 30 liters per square meter per hour.

2. The method according to claim 1, wherein said projectile has a volume of 1 liter.

3. The method according to claim 1, wherein said shuttle is a cannon of compressed air with a height regulator.

4. The method according to claim 1, wherein said shower of compact crushed ice is 35 liters per square meter per hour.

5. The method according to claim 1, wherein said shuttle in the second phase comprises cooling means that compensate for the friction heat between the projectile and the shuttle cannon.

6. A projectile for extinguishing fires of the type made from ice comprising a crushed ice mixture of a solution with a freezing point lower than 0° C. and wherein said projectile is compacted or bound with frozen freshwater.

7. A projectile according to claim 6, wherein said projectile comprises an additive with fire retardant.

8. A projectile according to claim 6, wherein said projectile has a volume of 1 liter.

9. A projectile according to claim 7, wherein said projectile comprises a member selected from the group consisting of a fluorescent pigment and a colorant.
